(19) United States
(12) Patent Application Publication
(10) Pub. No.: US 2011/0264590 A1
(43) Pub. Date: Oct. 27, 2011

(54) METHOD FOR INCREASING THE RATE OF TECHNOLOGICAL INNOVATION

(76) Inventor: David J. Muchow, Arlington, VA (US)

(21) Appl. No.: 13/072,584

(22) Filed: Mar. 25, 2011

Related U.S. Application Data
(60) Provisional application No. 61/282,743, filed on Mar. 25, 2010.

(51) Int. Cl. G06Q 10/00

(52) U.S. Cl. 705/300

(57) ABSTRACT

Methods are disclosed for managing innovation. In one aspect, a computer-implemented method for managing innovation includes receiving over a network, information regarding an uncommercialized product from a first party. The method further includes receiving resource information from a second party in response to the information, and facilitating communication between the first party and the second party regarding the development of the information toward a commercial product.

### BENEFIT OF PRIORITY

This application claims the benefit of Provisional Application No. 61/282,743, filed on Mar. 25, 2010, the entire contents of which is incorporated herein by reference.

### TECHNICAL FIELD

The present disclosure relates generally to increasing the rate of technological innovation.

### BACKGROUND

Many valuable and new products fail to reach commercialization at a time when competition is strong in the race for new environmental and other technologies. This is especially troubling considering the current emphasis on environmental technology to help countries regain competitiveness and create jobs.

Many products fail due to the vast amounts of time and money spent while developing a product. Steps such as setting up a new business, getting office equipment, licenses, developing a business plan, and then finding investors and customers can be daunting. A major hurdle in the path from an idea to a successful commercial product, is that there is no central repository, either a virtual one (such as on the Internet) or a physical place for all of the necessary parties, disciplines, products, and services, to come together. This is somewhat like trying to bake a cake without getting all the necessary ingredients together or having an oven in which to bake them. These necessary elements may include financial, research, technical, design, engineering, business, legal, government parties, fabrication, marketing, etc. As a result, by the time a simple prototype of a product is developed, the developer, who, may only have experience in one of these many disciplines, is likely to have spent a substantial amount of money or even decided not to continue.

In view of the foregoing, there is a need for an improved method to help bridge the gap from invention to commercialization and profitability and promote/develop environmental and other technologies.

### SUMMARY

One aspect of the disclosure relates to a computer-implemented method for managing innovation including receiving over a network, information regarding an uncommercialized product from a first party. The method further includes receiving resource information from a second party in response to the information, and facilitating communication between the first party and the second party regarding the development of the information toward a commercial product.

Another aspect of the present disclosure relates to a computer-implemented method for managing innovation, including receiving over a network, information regarding an uncommercialized product from a first party, comparing the information to a resource database, and providing the results of the comparison to the first party.

Another aspect of the present disclosure relates to a method of managing innovation, including providing a innovation facility, providing a first party possessing information relating to an uncommercialized product with access to the innovation facility, and providing a second party possessing resources for assisting in the development of the information toward a commercial product access to the innovation facility. The method further includes facilitating interaction between the first party and the second party regarding the development of the information toward a commercial product.

Before explaining exemplary embodiments of the present disclosure, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

The accompanying drawings, which are incorporated in and constitute a part of this specification, illustrate certain embodiments of the disclosure, and together with the description, serve to explain the principles of the disclosure.

As such, those skilled in the art will appreciate that the conception upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

FIG. 1 depicts an exemplary method for managing innovation.

FIG. 2 depicts another exemplary method for managing innovation.

FIG. 3 depicts another exemplary method for managing innovation.

### DETAILED DESCRIPTION

Reference will now be made in detail to the present embodiments of the disclosure, examples of which are illustrated in the accompanying drawings. Wherever possible, the same reference numbers will be used throughout the drawings to refer to the same or like parts.

Embodiments of the present disclosure relate to managing innovation, including facilitating and managing communication between multiple parties interested in promoting innovation. Parties interested in promoting technology may include, but are not limited to inventors, sellers, licensors, grantors, government agencies, private companies, universities, stakeholders, buyers, researchers, universities, venture capital firms, banks and financial institutions, engineers, government representatives, business firms, law firms, mutual funds, business publications, media, volunteers, a government service corps of retired executives, and any combination thereof.

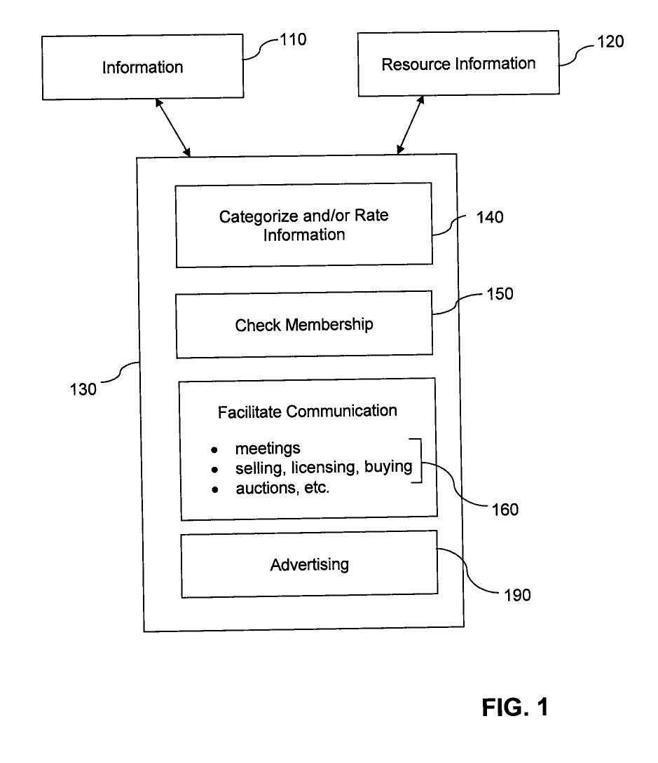

FIG. 1 illustrates one embodiment of the present disclosure. As further disclosed herein, this embodiment illustrates a method in which numerous parties may connect, interact, and share information and resources to help promote/develop innovation.

As shown in FIG. 1, a first party may have technology relating to a product that it wishes to promote/develop. This technology may be associated with a company or individual and relates to an uncommercialized product. For example, this technology may include ideas or innovations relating to new or improved products. The technology may be of any type, including environmental technology (technology that applies the environmental sciences to conserve the natural environment and resources). Associated with this technology, the first party may have information 110 regarding the same. This information may include, for example, technical information relating to the ideas or innovations, and/or may be questions regarding how to develop, market, and/or protect the ideas or innovations. The word “product” as used herein includes the product itself, and/or methods to make and/or facilitate making such a product. Further, the word “uncommercialized” used herein relates to products that are not currently a commercial product sold or owned by the first party.

A second party may possess resource information 120 for the promotion of this information 110. Resource information may be associated with a company or individual and include, but is not limited to funding, advice, financing, proposals, research, and other types of product development support.

As further shown in FIG. 1, a first party with information 110, and a second party with resource information 120 may communicate and engage in a variety of tasks and activities in a virtual marketplace 130. It is understood that the first party may include a plurality of first parties with different information 110, and the second party may include a plurality of second parties, each providing similar or different resources.

Virtual marketplace 130 may facilitate communication between the first party and the second party regarding the development of a product toward commercialization. Such communication may include a variety of transactions between the first and second parties regarding the development of the product. First and second parties may communicate with one another in virtual marketplace 130 via an electronic network (not shown), such as the Internet.

Virtual marketplace 130 may be associated with an entity that disseminates, publishes, generates, manages, or otherwise makes electronic content available over electronic network (not shown), such as the Internet. For example, virtual marketplace 130 may be associated with a content provider, a content publisher, a content creator, a search engine company, an Internet Service Provider (ISP), a mobile service provider, an online retailer, or any other entity concerned with providing electronic content over a network.

In addition, virtual marketplace 130 may be accessed through a website and include one or more server computers (not shown) connected to electronic network (not shown). Each server computer may include any combination of computing elements configured to facilitate communication and other various tasks and processes, consistent with embodiments of the present disclosure. For example, each server computer may include a central processing unit (“CPU”), a memory, a user interface, a data storage device, a network communication device, and/or any other computer elements known in the art.

First and second parties may access virtual marketplace 130 using a desktop computer, laptop computer, personal digital assistant (“PDA”), smartphone, mobile device, Internet-enabled television, automobile, or home, or any other mobile or electronic device configured to access electronic network.

As further shown in FIG. 1, according to one aspect of this embodiment of the present disclosure, virtual marketplace 130 may be programmed to provide for various functions facilitating communication between the first party and the second party. For example, virtual marketplace 130 may categorize the parties and/or information received 140 to better facilitate communication between the parties. Virtual marketplace 130 may also provide separate virtual rooms 160 using, for example, separate links to facilitate communication between first and second parties regarding the development of technology depending on each parties' interest for accessing virtual marketplace 130. For example, virtual marketplace 130 may create separate virtual rooms 160 where the parties can meet and share information. Such virtual meetings can be initiated based on the categorization or ratings, or based on identifiable categories, keywords, and/or topics inputted by parties regarding information 110 and/or resource information 120. For example, virtual rooms 160 may be created for the parties to meet based on the particular type of technology found in the information 110 or the type of transaction desired. Virtual rooms 160 may thus allow transactions between the first party with information 110 and the second party with resource information 120 including, but not limited to selling, licensing, buying, leasing, and/or auctions (open bid, closed bid, bid with time limits, Dutch auctions, and reverse auctions). Consideration within virtual marketplace 130 may include, but is not limited to credit, debit, and equity shares in a company or other entity.

Virtual marketplace 130 may generate revenue. Revenue may come from various methods, such as from advertising 190 on virtual marketplace 130 or memberships. Advertisers may represent any person or entity that desires to advertise on the electronic network, such as the Internet. For example, advertisers may represent online retailers, online service providers, financial institutions, product manufacturers, and/or any other entity that advertises goods or services electronically over a network. Alternatively or in addition, first and/or second parties may pay for access to virtual marketplace 130 with memberships, and the virtual marketplace 130 may be programmed to check for the membership (150 in FIG. 1) of one or both of the first and second parties before facilitating communication between the parties. Parties may agree to pay in to the virtual marketplace 130 on a pre visit, or subscription basis; or first parties with information 110 may pay with equity in their company if a deal resulted from their participation at the virtual marketplace 130, for example.

As mentioned above, rating systems may be established 140 so that first and/or second parties may rate the quality of the information 110 and resource information 120 provided by the parties on the site. These ratings may be displayed on virtual marketplace 130 for view by first and/or second parties. Ratings may be used by parties in advertising.

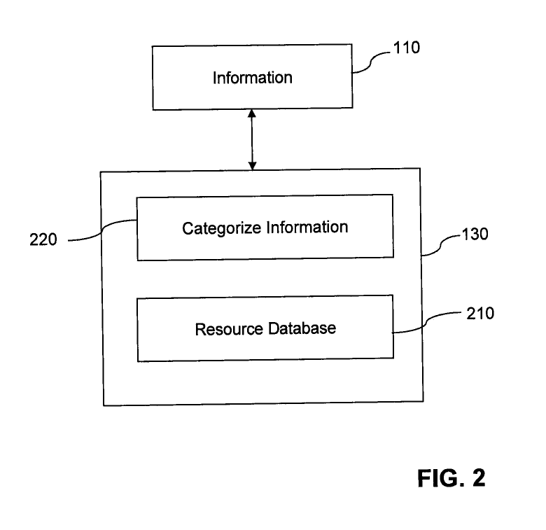

FIG. 2 illustrates another embodiment in which parties may connect, interact, and share information and resources to help promote/develop innovation.

As shown in FIG. 2, first party may again possess information 110 associated with a product it wishes to promote/develop. In this embodiment, virtual marketplace 130 may include a resource database 210 containing an inventory of resource information similar to the resource information 120 discussed above. Resource database 210 may include, but is not limited to, funding information, advice, financing, proposals, research, and other support.

Based on stored resource information within database 210 of virtual marketplace 130, virtual marketplace 130 may compare and match information 110 received from the first party to particular resource information found in resource database 210. When virtual marketplace 130 receives resources, it assigns each resource to a particular category based on certain factors. These factors may include but are not limited to a particular type of technology desired for the resources, for example, mechanical, electrical, environmental, etc. Additionally, when virtual marketplace 130 receives information 110, it also assigns the information 110 to a particular category based on similar factors (see 220 in FIG. 2). Consequently, when virtual marketplace 130 receives information 110 from a first party, virtual marketplace 130 may compare the category where the information was assigned and match the information with a resource in a similar category found in the resource database. The result of this comparison may then be outputted to the first party.

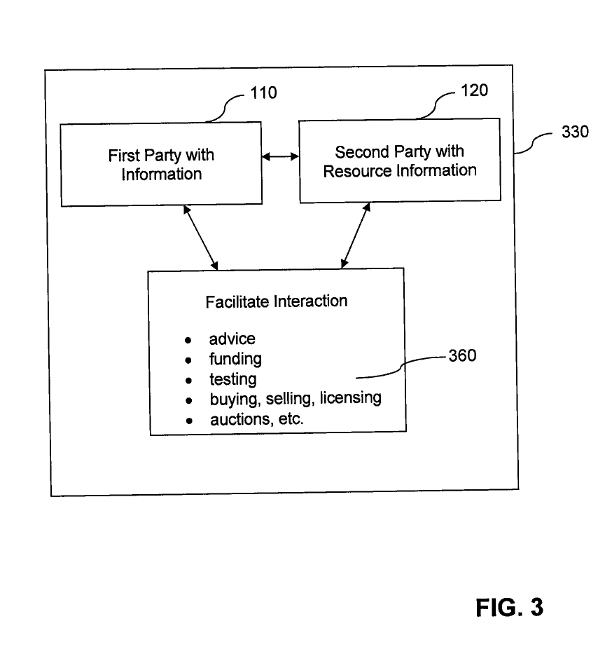

FIG. 3 illustrates another embodiment of the present disclosure in which parties may connect, interact, and share information and resources to help promote/develop innovation. As shown in FIG. 3, first and second parties may meet and engage in a variety of product development tasks and activities in an innovation facility 330. Innovation facility 330 may include a single building or a plurality of closely located buildings, such as those found in a common university.

In particular, first party with information 110 may wish to promote/develop a product. Second party with resource information 120 may wish to assist in the development of certain information 110. The information 110 and resource information 120 may include the same information discussed above. The innovation facility 330 may facilitate interaction between the first and second parties regarding the development of the product with the resource information 120 toward a commercial product.

Innovation facility 330 may facilitate interaction between the parties in a number of ways, such as, for example, providing a variety of different rooms or areas 360 for particular interactions. For example, rooms or areas 360 may be used for meetings and provide secretarial support, phones, copying machines and computers with CAD and engineering software. Additionally, rooms or areas 360 may be arranged so that first parties with information 110 can meet with and obtain advice on a variety of topics, such as intellectual property issues and/or marketing issues. The rooms or areas 360 may also provide for meetings with research institutions. Additionally, liaisons from Federal and State agencies may help inventors find government funding. Also, there may be high-bay facilities with space and power for basic mechanical and electrical fabrication so that prototypes could be built, tested, and demonstrated within rooms or areas 360. Other transactions that may occur within various rooms or areas 360 include, but are not limited to selling, licensing, buying, leasing, auctions (open bid, closed bid, bid with time limits, Dutch auctions, and reverse auctions).

According to another aspect of this embodiment of the present disclosure, rooms 360 may provide a fast track for promotion of inventions to commercialization. For example, inventors or others wishing to develop a new or improved product may present their ideas and/or inventions and a simple business plan to a panel of experts. After a certain time period, such as ten days, for example, a decision may be reached on whether or not to fund the development of the product and/or business plan. Winners may then immediately receive a substantial grant, which may be spent on activities provided by innovation facility 330. This money may be spent on legal support, engineering advice, and prototyping, for example. The approval process may include a clear outline of the project and a timetable. Funding may be done on a “self-licking ice cream cone” model, used by venture capital firms in which the firm makes an initial investment and receives an equity share or other interest in the company.

According to yet another aspect of this embodiment, innovation facility 330 may be self-funding over time. For example, federal or other types of funding may be used to initiate innovation facility 330 or facilities, for example one or more in each state. With respect to federal funding, such funding may be provided to each state with guidelines for their operation and enough flexibility for the states to create 50 different approaches, so the best-of-breed approaches could be replicated. Every first party receiving a grant may then pay a small percentage of the corresponding company's equity or equivalent monies to the innovation facility 330. If the product facilitated through innovation facility 330 develops into a profitable product, the first and/or second party may then pay back any funds received and/or a small profit for the innovation facility 330.

In addition, private venture capital may help fund innovation facilities 330. For example, private venture capital could augment government funds in a private sector-government partnership. Private investment group may raise private funds to co-invest with the government in starting up innovation facilities 330 Alternatively, private investment groups may handle the whole investment itself. This investment fund would be able to pick the best of the best of thousands of promising information 110 and reap a fair profit in return.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-implemented method for managing innovation, comprising:
receiving over a network, information regarding an uncommercialized product from a first party;
receiving resource information from a second party in response to the information; and
facilitating communication between the first party and the second party regarding the development of the information toward a commercial product.

2. The computer-implemented method of claim 1, wherein the resource information includes funding, financing, advice, or support.

3. The computer-implemented method of claim 1, wherein the information includes desired transaction information regarding the development, marketing, or protection of the product.

4. The computer-implemented method of claim 1, further including rating at least one of the first and the second parties, the information, or the resource information, and displaying at least a portion of the ratings.

5. The computer-implemented method of claim 1, further including requiring memberships by at least one of the first party or the second party before facilitating communication.

6. The computer-implemented method of claim 1, further including receiving varying resource information from additional parties, and wherein the first party may transact with one or more of the additional parties.

7. The computer-implemented method of claim 1, wherein the facilitating communication includes coordination of virtual meetings of the first party and the second party to conduct transactions relating to the information and the resource information.

8. The computer-implemented method of claim 7, wherein the facilitating communication further includes coordination of the virtual meeting of additional parties, and the transactions include the first party, second party, and additional parties engaging in an auction relating to one of the product or the resource information.

9. A computer-implemented method for managing innovation, comprising:
receiving over a network, information regarding an uncommercialized product from a first party;
comparing the information to a resource database; and
providing the results of the comparison to the first party.

10. The computer-implemented method of claim 9, wherein the resource information includes funding, financing, advice, or support.

11. The computer-implemented method of claim 9, wherein the information includes desired transaction information regarding the development, marketing, or protection of the product.

12. The computer-implemented method of claim 11, wherein the results are based on the received desired transaction information.

13. The computer-implemented method of claim 9, wherein the product includes environmental technology.

14. The computer-implemented method of claim 12, further including categorizing the information; and
wherein database includes different resource information based on the categorizing of the information.

15. A method of managing innovation, comprising:
providing a innovation facility;
providing a first party possessing information relating to an uncommercialized product with access to the innovation facility;
providing a second party possessing resources for assisting in the development of the information toward a commercial product access to the innovation facility; and
facilitating interaction between the first party and the second party regarding the development of the information toward a commercial product

16. The method of claim 15, wherein the facilitating interaction includes facilitating:
the first party in presenting the information to the second party,
the second party determining whether to use resources in the development of the product, and
the second party providing the first party a grant to be spent on other tasks within the innovation facility.

17. The method of claim 16, further comprising funding the innovation facility with governmental funds.

18. The method of claim 16, wherein the first party that receives a grant transfers money back to the innovation facility.

19. The method of claim 15, wherein the interaction between the first and second party includes at least one of giving advice, providing funding, providing testing, building of prototypes, giving demonstrations, buying, selling, licensing, or conducting an auction.

20. The method of claim 15, the product includes environmental technology.
